(19) United States
(12) Patent Application Publication
(10) Pub. No.: US 2008/0020087 A1
(43) Pub. Date: Jan. 24, 2008

(54) Method of treating and preserving wood

(76) Inventor: Phillip G. Landers, Sanford, FL (US)

Correspondence Address: William M. Hobby, III, 157 E. New England Avenue, #375, Winter Park, FL, 32789, US

(21) Appl. No.: 11/491,658

(22) Filed: Jul. 24, 2006

(51) Int. Cl. A23G 4/00

(52) U.S. Cl. 426/3

(57) ABSTRACT

A method of treating wood or other materials to deter animals, including birds, from chewing and pecking on the materials and to isolate toxic chemicals from the environment. The method includes preparing a basic composition which has isophorone and an epoxy resin and an epoxy catalyst and from 5 to 50 percent by weight of polyvinyl chloride. The basic composition is mixed with a polymer hardener to form a wood treating composition for wood or other materials which are impregnated with the wood treating composition under pressure to form a material resistant to animal chewing and pecking thereon and which simultaneously forms a shell or coating on the material to prevent leaching of the wood preservative from the wood. The process may include mixing the treating composition with a wood preservative.

### BACKGROUND OF THE INVENTION

Wood, often treated with toxic wood preserving chemicals, is used in the construction of building fences, stalls, corrals, and other structures to contain and house domestic and exotic animals and birds. These toxic chemical preservatives include, but are not limited to, creosote, pentachlorophenol, copper naphthenate and arsenic salts, such as copper chromated arsenic. Chewing on and ingestion of both treated and untreated wood is known to cause severe medical problems and even the death of these animals. In addition, wood chewing can compromise the structural integrity and aesthetic appeal of the wood. Examples of such chewing can be found in domestic animals, such as dogs that chew on woodwork and furniture and horses that chew and “crib” on wooden fences, stalls, posts, and other wood structures used to house and contain them. Wood chewing by more exotic zoo animals is also prevalent.

While possibly not the worst of the wood chewing animals, horses, because of their numbers, inflict significant economic damage as a result of cribbing and wood chewing. It is thought that when a horse cribs on wood, his body releases endorphins, natural “drugs” which stimulate the pleasure center of his brain, so that he receives a “reward” (“pleasure drug”) every time he cribs. Often cribbers would rather crib than eat. Wood chewing horses can suffer colic from eating wood splinters.

Isophorone (3,5,5-trimethyl-2-cyclohexen-one-1) compounds have been shown effective in deterring woodpeckers when painted on wood. Isophorone compounds have been shown in my U.S. Pat. No. 6,237,305 and No. 6,576,673 to be highly effective in penetrating and sealing wood. The coating will migrate through moisture and is highly miseable in water and will liquify certain types of preservatives. It is used with paraffin wax to provide a water repellant barrier and surface coating on the wood. Field tests have shown that these formulations, while effective for woodpecker deterrence, do not provide long-term protection against wood chewing by larger animals, such as horses.

My prior U.S. Pat. No. 6,749,862 and No. 6,908,643 also describe surface coatings. U.S. Pat. No. 6,749,862 deters woodpeckers by blending isophorone with an epoxy resin and acrylic based sealant to form a resin composition and mixing the resin composition with a solvent resistant epoxy hardener to form a coating material.

U.S. Pat. No. 6,908,643 expands the technology and prevents animals from chewing on a structure with a composition which includes isophorone, organic-clay absorber, Bisphenol A Diglycidal Ether Polymer and polyamide resin harder. This patent expands the technology to horses and other animals with the addition of absorbers and glass flakes or mica as well as a microencapsulated acrylic resin-based sealant and a flocculated silica thickener.

The primary binder of each coating is epoxy and the targets of each have been horses, woodpeckers and other animals, such as dogs.

My U.S. patent application Ser. No. 11/061,970 is a composition for deterring animals from chewing on wood and is also an epoxy-based coating. In this application, various amounts of a PVC resin can be used in place of the epoxy.

The present invention expands on my prior inventions by substituting all or a portion of the epoxy resins/hardener binders of the above formulations with PVC resins, both homo-polymer PVC and co-polymer PVC and blending this formulation with wood preserving chemicals, both oil-borne and water-borne and applying the formulation by pressure treating with either positive or negative pressure with or without the application of external heat. These enhancements expand the application technology from that of a surface coating to pressure treating wood and thus from a limited number of animals to all treated wood applications. PVC coating with or without the epoxy prevents toxic chemicals, such as arsenic, used in the wood preservatives from leaching into the soil. The PVC deposits on the surface of the wood while the wood preservative and isophorone impregnates the wood.

The present invention describes a method of deterring animals by impregnating wood by pressure treating or injecting wood or any porous material. The composition can be added to a wood treatment chemical and the wood pressure treated in one process. This invention is an improvement over my previously patented isophorone deterrent technology in that it substantially improves the animal deterrence of woodpeckers and other animals, such as horses and dogs, against chewing and pecking and allows for pressure treating the wood to preserve the wood against fungus, insects and rot.

### SUMMARY OF THE INVENTION

A method of treating wood or other materials to deter animals, including birds, from chewing and pecking on the materials. The method includes preparing a basic composition which has isophorone and an epoxy resin and an epoxy catalyst and from 5 to 50 percent by weight of polyvinyl chloride. The basic composition is mixed with a polymer hardener to form a wood treating composition for wood or other materials which are impregnated with the wood treating composition under pressure to form a material resistant to animal chewing and pecking thereon. The process may include mixing the treating composition with a wood preservative and impregnating the wood with the wood treating and preservative mixture. The composition might also include absorbers, such as an organo-clay or a precipitated silica, and may include glass or mica flakes added to the composition. The wood may be impregnated by pressure treating the wood so that the treating composition can penetrate the surface of the wood. It can also be impregnated by ejecting the treating composition into the wood. The polyvinyl chloride can include a polyvinyl co-polymer and/or a polyvinyl homo-polymer.

### DESCRIPTION OF THE PREFERRED EMBODIMENT

The present invention describes a method of deterring animals especially larger animals, such as horses, from chewing on structures, especially wood, and for deterring animals, such as birds, from pecking on structures, such as wooden utility poles, fences, and other structures and to the process of simultaneously preserving wooden structures. Wood or other structural materials are impregnated with a treating composition in which the basic composition includes isophorone and an epoxy resin, including either or both Bisphenol A Diglycidal Ether and/or Bisphenol F Diglycidal Ether, and an epoxy catalyst, and from 1 to 20 percent by weight of polyvinyl chloride (PVC) which may include a polyvinyl chloride homo-polymer and/or polyvinyl co-polymer. The basic composition may have absorbers added thereto including organo-clays and precipitated silicas. It may also have various fillers including glass or mica flakes or similar materials added thereto. The basic formula is then mixed with an polyamide resin (epoxy) hardener and then PVC homo-polymer. The composition can be impregnated into a structural material, such as wood, under pressure to form materials that are resistant to animal chewing and pecking thereon. Isophorone readily dissolves the PVC co-polymer in the basic liquid composition but the PVC homo-polymer, which is not as readily dissolved, is mixed into the polyamide hardener and is not dissolved and deposits on the surface of the wood being treated to form a water resistant barrier. This barrier prevents the wood preserving materials, which may contain toxic materials, from leaching from the wood.

The basic process includes mixing the basic composition with a wood preservative including a waterborne wood preservative, such as chromated copper arsente or acid copper chromate or a chromated zinc chloride with the addition of a surfactant. The basic composition can also be added to an oil-type preservative, such as creosote or pentachlorophenol.

Tests on the present isophorone and PVC composition have shown an approximately 25% improvement in deterring animals from chewing or pecking on wood, as compared to my prior compositions and methods. A specific formula includes by weight 25-50% isophorone (3,5,5-trimethyl-2-cyclohexen-one-1); 20-50% epoxy resins (Bisphenol A Diglycidal Ether or Bisphenol F Diglycidal Ether) and 0.5 to 1.5% catalyst; polyvinyl chloride (PVC) of from 5-50%, which may include a PVC homo-polymer of from 0-40% and a PVC co-polymer from 0-10%. A polyamide (epoxy) hardener for the epoxy resins would typically be about 50% of the total epoxy resins in the composition. The PVC's act as an absorber for the isophorone but additional absorbers can be added to make up as much as 20-30% of the composition and include organo-clays and precipitated silicas. The composition can also include glass and mica flakes.

### EXAMPLE

A specific formula includes, by weight, 27% Bisphenol A Diglycidal Ether; 3% Bisphenol F Diglycidal Ether; 29% isophorone; 14% clay and silica absorbers; 1% epoxy catalyst; 15% polyamide resin hardener; 2% polyvinyl chloride co-polymers; 4% polyvinyl chloride homo-polymers; 4% hydrophobic filling and 1% of various color pigments. The combination may also optionally include glass or mica flakes.

The composition can be applied to a structure, especially to a wood structure, by pressure treating the wood or by injection or may be troweled onto the surface.

The method also includes the addition of a wood preservative to the basic composition. Since isophorone is a solvent, the composition can be mixed directly with an oil-type preservative, such as pentachlorophenol or creosote and then the wood pressure treated with the mixture of the preservative and the animal deterrent. The mixture can also be added to a waterborne preservative with the addition of a surfactant to the mixture. Waterborne preservatives include chromated copper arsenate (CCA) or ammoniacol copper zinc (ACZA) or acid copper chromate (ACC) and chromated zinc chloride (CZC).

There are two basic types of wood preservatives in commercial use, an oil-type preservative and a water-borne preservative. Oil-type preservatives include copper naphthenate, creosote or creosote solutions and pentachlorophenol while water-borne preservatives include ACZA (Ammoniacal Copper Zinc Arsenate) and ACQ (Ammonical Copper Quat) or CCA (Chromated Copper Arsenate) or Copper Azole.

When used with the oil-type preservatives, the isophorone and PVC formulation, as described, is blended directly with the oil-type preservative into a solution ranging from 10% to 60% isophorone/PVC formulation and 40% to 90% oil-type preservative. The resulting solution is then forced into the wood using conventional pressure treating methods. If an isophorone/PVC concentration greater than 40% is used, the addition of heat is required during the pressure treated process. When the isophorone/PVC formulation is to be used with water-borne type preservatives, the addition of a non-ionic surfactant is required to prevent separation of the solution. The isophorone/PVC formulation is used in a range between 10% to 60% along with 1% to 10% non-ionic surfactant and from 40% to 90% water-borne type preservative. The resulting solution is forced into the wood using conventional pressure treating methods. For an isophorone/PVC concentration greater than 40%, the addition of heat is required during the pressure treatment process.

Isophorone (3,5,5-trimethyll-2-cyclohexen-one-1) is obtained from Union Carbide. The glass flake can be 1/32″ glass flake obtained from Glass Flake International but mica can also be used. The absorber or clay thickener is Claytone APA from Southern Clay Products and a flocculated silca thickener can be obtained from Degusa Aerosil 200. Epoxy resins can be obtained from Shell Chemical under their formulation Epon 828 and the polyamide resin is obtained from Cognis Corporation under their formula Versamid 140. Polyvinyl resins are obtained from Polyone Corporation. The epoxy catalyst can be obtained from ICORP-IFOAM specification product under the formulation IFOAM Part B Catalyst. The hydrophobic fillers can be obtained from Degusa Corporation.

When the composition is combined with a wood preservative and then the mixture impregnated into the wood, such as by pressure treating or injecting, it cures to form a treated water resistant PVC coating over the wood surface that deters animals and woodpeckers from chewing and pecking on the wood. The coating formed on the wood is water resistant and protects the wood from animals chewing or birds pecking on the wood and simultaneously acts as a wood preservative against deterioration from fungus and mold growth and from insect damage.

Toxic wood preserving chemicals are typically leached from treated wood into the soil. Combining the PVC and PVC co-polymer effectively isolates these toxic chemicals from the environment by depositing/filtering out a polymer “shell” over the outside of the wood as the preservative and isophorone compound is forced/absorbed into the wood. Additional effectiveness is obtained by making the polymer shell hydrophobic through the addition of waxes, either paraffin or other waxes, such as polypropylene, polyethylene, or micro-crystalline waxes. These waxes can be used either stand-alone or in combination with hydrophobic fillers, such as Hydrophobic Fumed Silica, such as marketed by Degussa under the trade names Minusil 972 or Minusil 974 or Hydrophobic Precipitated Silica, such as marketed by Degussa under the trade names Sipernat D10 and Sipernat D17.

The method of isolating toxic chemicals used as wood preservatives from the environment includes preparing a composition having a wood preservative, and an epoxy resin and an epoxy catalyst and 1 to 20 percent by weight of a polyvinyl chloride and mixing a polymer hardener to the prepared composition to form a wood treating composition. This wood treating composition is then impregnated into wood under pressure to form impregnated wood having a polymer shell on the surface of the wood thereby isolating the toxic wood preservatives in the wood from the environment. The composition polyvinyl chloride includes a polyvinyl chloride co-polymer and may include a polyvinyl chloride homo-polymer to deposit a polyvinyl chloride surface on said wood being coated.

The method includes treating the structure or materials such as wood, to deter animals from chewing and pecking on the materials and prepares a composition having isophorone and an epoxy resin and an epoxy catalyst and from 1-20%, by weight, of polyvinyl chloride. The PVC co-polymer is added to the basic mixture and the PVC homo-polymer is added to the epoxy hardener. The composition may also include absorbers or fillers, such as organic clays and precipitated silicas added thereto along with glass and mica flakes as desired. The basic composition is mixed with an epoxy polymer hardener having the PVC homo-polymer added thereto to form a wood treating composition. 10% to 40% by weight of this composition is added to 60% to 90% by weight of a wood preservative so that when the composition is impregnated into a structure, such as wood utility poles or wooden fences, the material or wood is made resistant to animal chewing and pecking thereon and is also made water resistant. The use of a powdered PVC resin has been found to substantially enhance the current capability of the material treated with the basic composition as well as to add water resistance to the material.

The present invention should not be construed as limited to the forms disclosed herein which should be considered illustrative rather than restrictive.

I claim:

1. A method of treating material to deter animals from chewing and pecking on material comprising the steps of:
preparing a composition comprising isophorone, and an epoxy resin and an epoxy catalyst and 1 to 20 percent by weight of polyvinyl chloride;
mixing a polymer hardener to the prepared composition to form a material treating composition; and
impregnating material with said material treating composition under pressure to form an impregnated material having a polymer shell resistant to animals chewing and pecking thereon.

2. The method of treating material to deter animals from chewing and pecking on material in accordance with claim 1 in which the step of preparing a composition includes preparing a composition in which the polyvinyl chloride is a polyvinyl chloride co-polymer.

3. The method of treating material to deter animals from chewing and pecking on material in accordance with claim 2 including the step of mixing a polyvinyl chloride homo-polymer to the composition prior to applying the composition to the material so that polyvinyl chloride surface will be deposited on said material being coated.

4. The method of treating material to deter animals from chewing and pecking on material in accordance with claim 1 including the step of mixing said material treating composition with a wood preservative and impregnating wood with said material treating composition and wood preservative mixture.

5. The method of treating material to deter animals from chewing and pecking on material in accordance with claim 1 including the step of mixing said material treating composition with a water based wood preservative and a surfactant and impregnating wood with said material treating composition and wood preservative mixture.

6. The method of treating material to deter animals from chewing and pecking on material in accordance with claim 1 in which the step of preparing a composition includes preparing a composition having an epoxy catalyst.

7. The method of treating material to deter animals from chewing and pecking on material in accordance with claim 1 in which the step of preparing a composition includes preparing a composition having an organic-clay absorber therein.

8. The method of treating material to deter animals from chewing and pecking on material in accordance with claim 7 in which the step of preparing a composition includes preparing a composition having glass or mica flakes therein.

9. The method of treating material to deter animals from chewing and pecking on material in accordance with claim 4 in which the step of preparing a composition includes preparing a composition having an 25 to 40 percent by weight of isophorone.

10. The method of treating material to deter animals from chewing and pecking on material in accordance with claim 9 in which the step of preparing a composition includes preparing a composition having an 20 to 30 percent by weight of epoxy resins.

11. A composition for treating material to deter animals from chewing and pecking on the material comprising by weight: 25 to 40 percent isophorone, 20 to 30 percent epoxy resins, 0.5 to 1.5 epoxy catalyst, 1 to 10 percent polyvinyl chloride copolymer, 5 to 40 percent polyvinyl chloride homo-polymer and 10 to 20 percent polyamide resin hardener.

12. The composition for treating material to deter animals from chewing and pecking on the material in accordance with claim 11 combined with a wood preservative for pressure treating wood.

13. A method of preserving wood comprising the steps of:
preparing a composition comprising isophorone, and an epoxy resin and an epoxy catalyst and 1 to 20 percent by weight of polyvinyl chloride;
mixing 10 to 40 percent by weight of said composition with 60 to 90 percent by weight of a wood preservative to form a wood preservative composition;
mixing a polymer hardener to said prepared wood preservative composition to form a wood treating composition; and
pressure treating wood with said material treating composition under pressure to form treated wood resistant to wood rot and to animals chewing and pecking thereon.

14. The method of preserving wood in accordance with claim 13 including the step of mixing said composition with a wood preservative includes mixing 10 to 40 percent by weight of said composition and 60 to 90 percent by weight of an oil type wood preservative.

15. The method of preserving wood in accordance with claim 13 including the step of mixing said composition with a wood preservative includes mixing 10 to 40 percent by weight of said composition and 60 to 90 percent by weight of a water type wood preservative and 1 to 10 percent by weight of a non-ionic surfactant.

16. A composition for treating wood comprising by weight: 10 to 40 percent of a composition having 25 to 40 percent isophorone, 20 to 30 percent epoxy resins, 0.5 to 1.5 epoxy catalyst, 1 to 10 percent polyvinyl chloride copolymer, 5 to 40 percent polyvinyl chloride homo-polymer and 10 to 20 percent polyamide resin hardener, and a 60 to 90 percent of a wood preservative.

17. The composition for treating wood in accordance with claim 16 in which said wood preservative is a water borne wood preservative and said composition includes 1 to 10 percent by weight of an ionic surfactant.

18. The composition for treating wood in accordance with claim 16 in which said wood preservative is an oil based wood preservative.

19. A method of isolating toxic chemicals used as wood preservatives from the environment comprising the steps of:
preparing a composition having a wood preservative, and an epoxy resin and an epoxy catalyst and 1 to 20 percent by weight of polyvinyl chloride;
mixing a polymer hardener to the prepared composition to form a wood treating composition; and
impregnating wood with said wood treating composition under pressure to form impregnated wood having a polymer shell on the surface of the wood thereby isolating said toxic wood preservatives in the wood from the environment.

20. The method of isolating toxic chemicals used as wood preservatives from the environment in accordance with claim 19 in which the step of preparing a composition includes preparing a composition in which said polyvinyl chloride includes a polyvinyl chloride co-polymer.

21. The method of isolating toxic chemicals used as wood preservatives from the environment in accordance with claim 19 including the step of mixing a polyvinyl chloride homo-polymer to the composition prior to applying the composition to the wood so that polyvinyl chloride surface will be deposited on said wood being coated.

22. The method of isolating toxic chemicals used as wood preservatives from the environment in accordance with claim 21 in which the step of preparing a composition includes preparing a composition having 25 to 40 percent by weight of isophorone.
